(19) United States
(12) Patent Application Publication
(10) Pub. No.: US 2026/0299996 A1
(43) Pub. Date: Oct. 1, 2026

(54) METHOD AND SYSTEM FOR STREAMING TRANSMISSION

(71) Applicant: WISTRON CORPORATION, New Taipei City (TW)

(72) Inventors: Yan Yin KE, New Taipei City (TW); Kuan Wei TSAI, New Taipei City (TW); Yu Yuan CHANG, New Taipei City (TW); Tzu Wei HUNG, New Taipei City (TW); Chen Ying LIN, New Taipei City (TW)

(73) Assignee: WISTRON CORPORATION, New Taipei City (TW)

(21) Appl. No.: 19/240,260

(22) Filed: Jun. 17, 2025

(30) Foreign Application Priority Data
Mar. 25, 2025 (TW) 114111183

(51) Int. Cl. G06F 9/48

(52) U.S. Cl. CPC G06F 9/485; G06F 2209/541

(57) ABSTRACT

This disclosure provides a method and a system for streaming transmission. The method includes: receiving a request from a client and establishing a task based on the request; calling a language model when executing the task to continuously generate multiple data fragments and storing these data fragments in a stream pool; receiving a query corresponding to the task from the client and determining whether the task is completed; in response to the task being completed, establishing a one-time connection with the client to send all the stored data fragments; and in response to the task not yet being completed, establishing a stream connection with the client to send an existing stored data fragments to the client, continuously receiving a subsequent data fragment from the language model, and transmitting the subsequent data fragment to the client through the stream connection.

### CROSS-REFERENCE TO RELATED APPLICATION

This application claims the priority and benefit of Taiwan application serial no. 114111183, filed on Mar. 25, 2025, the disclosure of which is hereby incorporated in its entirety by reference herein.

### TECHNICAL FIELD

This disclosure relates to a stream transmission method and system for data transmission using a language model to complete tasks.

### BACKGROUND

### Description of Related Art

With the flourishing development of artificial intelligence (AI) and deep learning technology, Large Language Models (LLM) have become core tools in the field of natural language processing, with their application scope covering voice assistants, language translation, automatic summary generation, and many other scenarios. In some applications, AI agent plays an intermediary role in calling large language models, responsible for receiving requests from the client, and utilizing the computing power of large language models to complete complex tasks, such as text analysis, answering questions, or generating content. Subsequently, the client will get the execution results of these tasks through the way of query.

The client typically adopts polling to query whether the agent has completed the task and obtained the result. The working principle of this polling mechanism is that the client continuously sends query requests to the agent at certain time intervals to detect the status of task execution. On one hand, the agent needs to process frequent queries from the client, leading to excessive consumption of system resources; on the other hand, when the task execution time is longer, too frequent polling may increase unnecessary load, while too sparse polling may increase the latency of query results.

### SUMMARY

The present disclosure provides a method and system that effectively reduces the resource consumption of the agent while ensuring that the client can get task execution results in real time. The present disclosure proposes a stream transmission method and system.

This disclosure proposes a stream transmission method performed by a computer system. This method includes: receiving a request from a client, and establishing a task according to this request; when executing the task, calling a language model to continuously generate multiple data fragments, and storing these data fragments in a stream pool; receiving a query corresponding to the task from the client, and determining whether the task is completed; in responding to the task being completed, establishing a one-time connection with the client to send all of the stored data fragments to the client; and in responding to the task not yet being completed, establishing a stream connection with the client to send the existing stored data fragments to the client, continuously receiving a subsequent data fragment from the language model, and sending the subsequent data fragment to the client through the stream connection.

From another perspective, the embodiment of this disclosure proposes a stream transmission system, including a client and a server. The server is communicatively connected to the client. The server receives a request from the client, and establishes a task according to the request. When executing the task, the server calls a language model to continuously generate multiple data fragments, and stores the data fragments in the stream pool. The server receives a query corresponding to the task from the client, and determines whether the task is completed. In response to the task being completed, the server establishes a one-time connection with the client to send all stored data fragments to the client. In response to the task not yet completed, the server establishes a stream connection with the client to send the stored data fragments to the client, continuously receive a subsequent data fragment from the language model, and sends the subsequent data fragments to the client through the stream connection.

### BRIEF DESCRIPTION OF THE DRAWINGS

FIG. 1 is a schematic diagram illustrating a stream transmission system according to an embodiment.

FIG. 2 is a flowchart illustrating the transmission process when a task is completed according to an embodiment.

FIG. 3 is a flowchart illustrating the transmission process when a task is not yet completed according to an embodiment.

FIG. 4 is a schematic diagram illustrating a stream transmission system according to an embodiment.

FIG. 5 is a flowchart illustrating the implementation of function call according to an embodiment.

FIG. 6 is a flow diagram illustrating a stream transmission method according to an embodiment.

### DETAILED DESCRIPTION

Some embodiments of the present disclosure will be described in detail with reference to the accompanying drawings. In the following description, when the same element symbols appear in different drawings, they will be regarded as the same or similar elements. These embodiments are only a part of the disclosure and do not disclose all possible implementations of the disclosure. More precisely, these embodiments are only examples of the systems and methods in the scope of patent claims of the present disclosure.

Regarding the terms “first”, “second”, etc. used in this document, they do not specifically refer to order or sequence, but are merely used to distinguish elements or operations described with the same technical terminology.

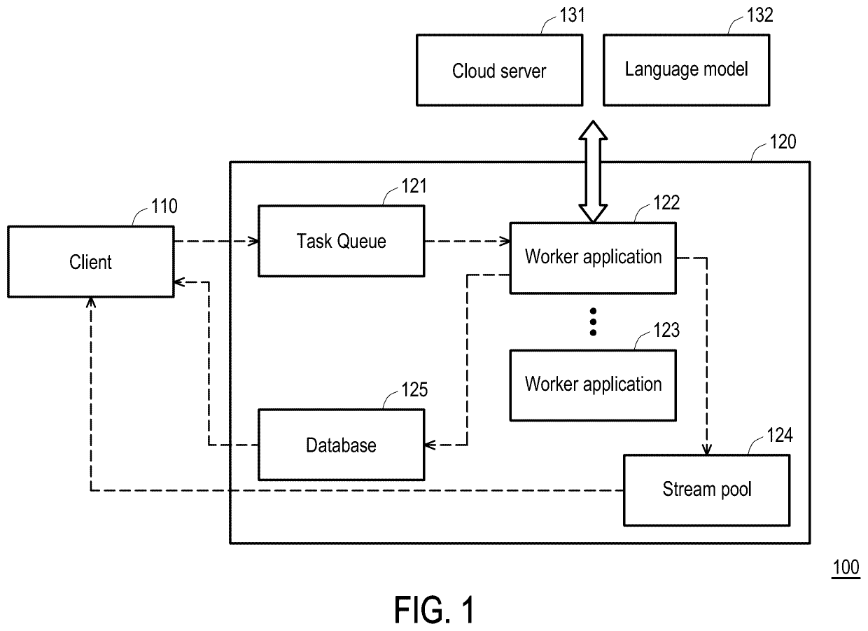

FIG. 1 is a schematic diagram illustrating a stream transmission system according to an embodiment. Referring to FIG. 1, a stream transmission system 100 includes a client 110 and a server 120, wherein the client 110 is communicatively connected to the server 120. The client 110 may be a user device or another server. For example, the client 110 may be a personal computer, smartphone, laptop, tablet computer, etc. An application, such as a chatbot, artificial intelligence agent, customer service machine, etc., is executed on the client 110 and this application will send a request to the server 120. In some embodiments, the client 110 is another server that sends requests to the server 120 after interacting with other devices.

The server 120 runs multiple worker applications 122-123, and the server 120 also establishes a task queue 121, a stream pool 124, and a database 125. The task queue 121 and the stream pool 124 contain stream data structures. For example, the task queue 121 and the stream pool 124 may be implemented using Redis, but the present disclosure is not limited to this. In other embodiments, Kafka may be used for implementation. The worker applications 122-123 retrieve a task from the task queue 121 and execute this task. For example, the worker applications 122-123 may be implemented as workers under the Celery framework.

The server 120 receives a request from the client 110 and establishes a task based on this request. This request may include one or more texts, images, symbols, and other data. The purpose of this request may be to ask questions, generate images, generate code, generate summaries, process images, etc., but the present disclosure is not limited to these. The server 120 will establish an identifier, status, etc. for the task, and this status at least indicates whether the task has been completed. The task established by the server 120 is added to the task queue 121. Each worker application 122-123 retrieves a task from the task queue 121 and executes the task when there are sufficient resources. In other words, the execution of tasks is asynchronous. In some embodiments, the server 120 may adopt KEDA (Kubernetes Event-driven Autoscaling) to manage the worker applications 122-123.

When the worker applications 122-123 execute tasks, they call a language model 132. In some embodiments, the language model 132 is provided by other servers, and the server 120 may call the language model 132 through an application interface (API). In other embodiments, the language model 132 is deployed on the server 120. This language model 132 may be from the GPT (Generative Pre-trained Transformer) series, Gemini, BERT (Bidirectional Encoder Representations from Transformers) series, LLaMA (Large Language Model Meta AI), etc., but the present disclosure is not limited to these. The worker applications 122-123 may input questions from the client 110 to the language model 132, and the language model 132 will continuously generate data fragments, which are stored in the stream pool 124. Each data fragment may include one or more chunks, tokens, pixels, etc., but the present disclosure is not limited to these.

When the server 120 receives a query about a task from the client 110, the server 120 will first determine whether this task has been completed. If the task has been completed, the server 120 will establish a one-time connection with the client 110 to send the corresponding data fragments to the client 110. If the task has not been completed, the server 120 will establish a stream connection with the client 110 to send the corresponding data fragments to the client 110. After that, when the language model 132 generates subsequent data fragments, the server 120 will send these subsequent data fragments to the client 110 through the stream connection. However, in this embodiment, the server 120 may establish different connections according to whether the task has been completed, and when the task has not been completed, data is sent in a streaming way, which can avoid unnecessary polling.

In some embodiments, the requests sent by the client 110, the one-time connection, and the stream connection all comply with HyperText Transfer Protocol (HTTP). For example, the above-mentioned requests include GET or POST commands, and the stream connection is a Server-Sent Event (SSE) connection. When establishing a one-time connection, the server 120 closes the connection after responding (i.e., sending data fragments). If the client 110 wants to continue querying the task, it must re-establish the connection. In contrast, when establishing a stream connection, the connection is not closed after transmitting data fragments, so there is no need to re-establish the connection when sending subsequent data fragments. In this way, if the task has not been completed, once the language model 132 generates new data fragments, these data fragments will be sent to the client 110 through the stream connection, which can reduce the waiting time for the client 110 to receive data fragments.

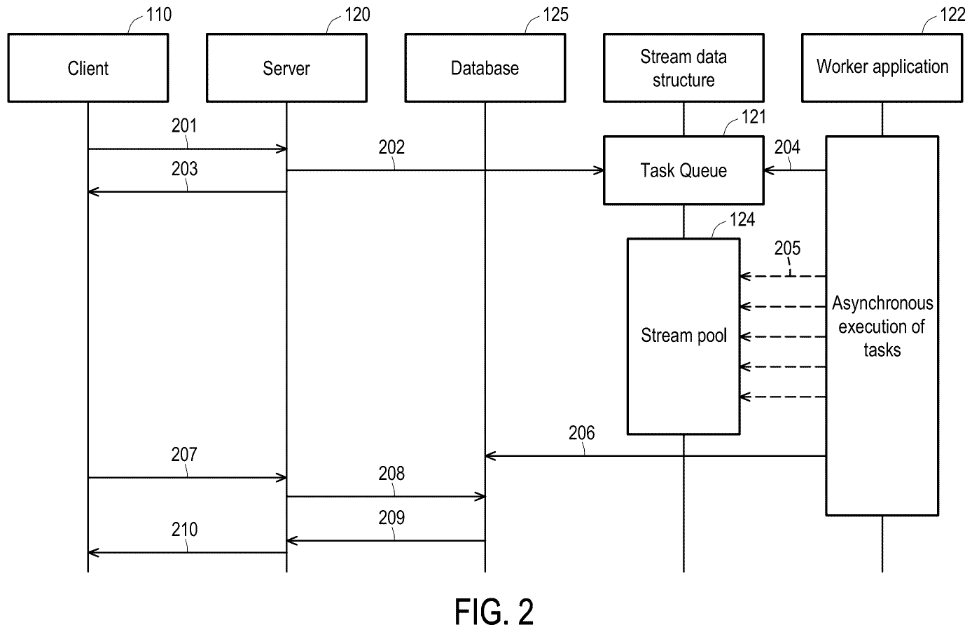

FIG. 2 is a flowchart illustrating the transmission process when a task is completed according to an embodiment. Referring to FIG. 2, first in step 201, the client 110 sends a request to the server 120. In step 202, the server 120 establishes a task corresponding to this request and adds this task to the task queue 121. In step 203, the server 120 sends the identifier of this task to the client 110. Taking the worker application 122 as an example, in step 204, the worker application 122 retrieves the task from the task queue 121 and calls the language model to execute this task. The worker application 122 continuously receives multiple data fragments from the language model and stores these data fragments in the stream pool 124 in step 205. When the task is completed, in step 206, the worker application 122 stores the task result formed by all data fragments in the database 125. Next, in step 207, the client 110 sends a query for this task to the server 120, which includes the identifier of the task. In step 208, the server 120 queries whether there is a task result for this task in the database 125, thereby determining whether the task is completed. If the database 125 does not include the task result, it is determined that the task has not been completed; if the database 125 includes the task result, it is determined that the task has been completed. In this example, since the task has been completed, in step 209, the server 120 retrieves the task result from the database 125. In step 210, the server 120 establishes a one-time connection with the client 110 and sends the task result (including all of the stored data fragments) to the client 110 through the one-time connection.

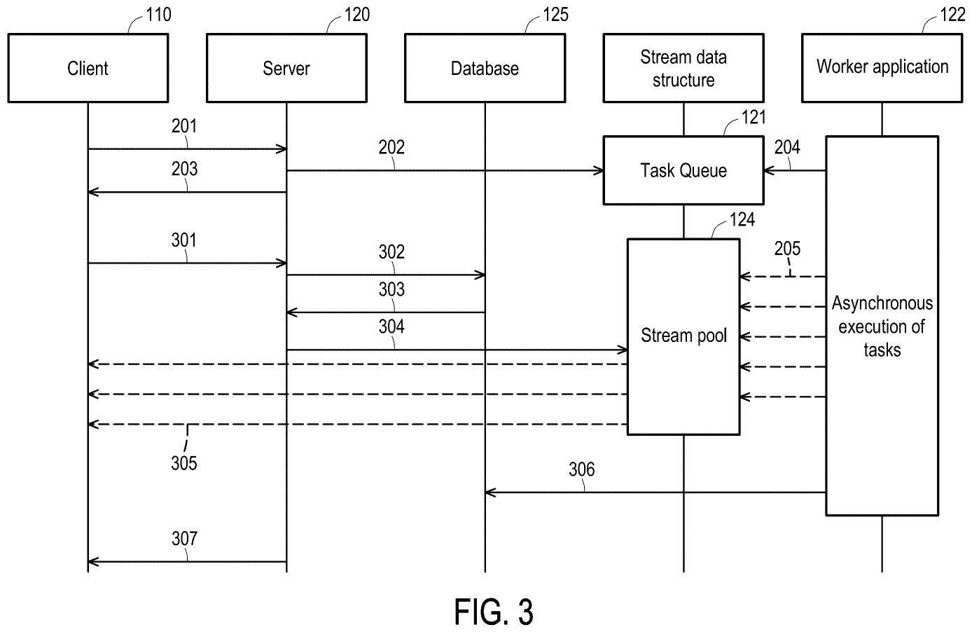

FIG. 3 is a flowchart illustrating the transmission process when a task is not yet completed according to an embodiment. Referring to FIG. 3, steps 201-205 are the same as the process in FIG. 2, and thus the description will not be repeated here. In step 301, the client 110 sends a query for the task to the server 120. In step 302, the server 120 queries whether there is a task result for this task in the database 125, thereby determining whether the task is completed. In this example, since the task is not yet completed, in step 303, the database 125 returns a query result indicating that the task is not yet completed (i.e., no task result is available) to the server 120. In step 304, the server 120 sends a request to the stream pool 124, requesting the stream pool 124 to transmit the stored data fragments. Next, in step 305, the server 120 establishes a stream connection with the client 110 and continuously sends the existing data fragments already stored in the stream pool 124 to the client 110 through the stream connection. When the language model continuously generates subsequent data fragments, these subsequent data fragments are also added to the stream pool 124 and sent to the client 110 through the stream connection. In step 306, the task is completed, and the worker application 122 stores the task result in the database 125. The task result includes the aforementioned stored data fragments and subsequent data fragments. In step 307, the server 120 sends a message to the client 110 to indicate that the task has been completed.

In this embodiment, the client 110 does not directly call the language model 132 but through the server 120, in other words, the server 120 acts as an intermediary between the client 110 and the language model, one of the benefits of doing this is that the server 120 may temporarily store data fragments. In this embodiment, data fragments are temporarily stored in the stream pool 124. If the client 110 loses data fragments, for example, when events such as application crashes, power outages, system crashes occur, the client 110 may send a message to the server 120, and the server 120 will retrieve the data fragments from the stream pool 124, and send these data fragments to the client 110 again.

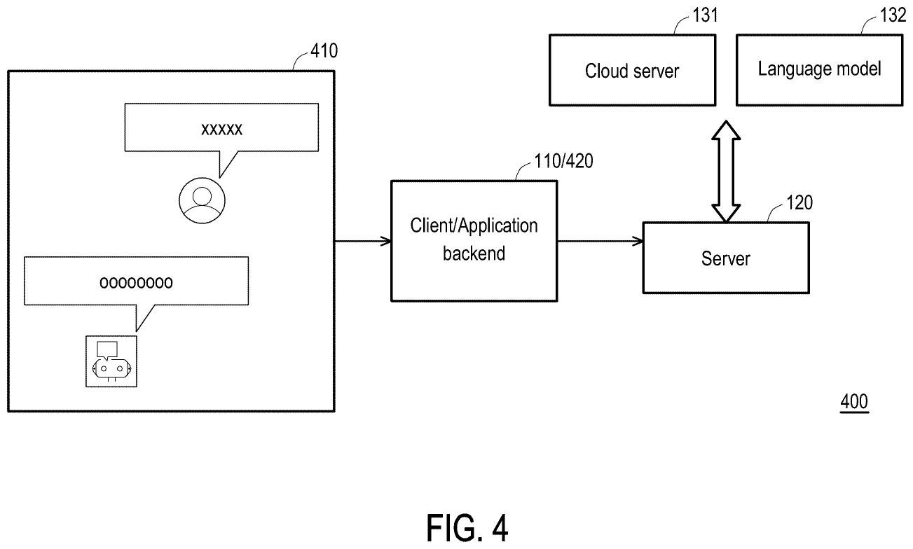

FIG. 4 is a schematic diagram illustrating a stream transmission system according to an embodiment. In the embodiment of FIG. 4, a stream transmission system 400 includes an application frontend 410, an application backend 420, and the server 120, where the application backend 420 is also referred to as the client 110. In this example, the application frontend 410 is used to provide a user interface, where the user may input questions to be answered by a chatbot. For example, the application frontend 410 runs on user devices such as mobile phones, personal computers, etc. The application backend 420 serves as a server for the application frontend 410, used to receive user input (for example, a question). The application backend 420 also acts as the client 110 mentioned above, in other words, the application backend 420 plays the role of triggering tasks and getting task results. The application backend 420 receives user input from the application frontend 410, and generates a request to the server 120 based on this user input, where the server 120 establishes a task and calls the language model 132 in an asynchronous way to complete this task. The server 120 will send the data fragments output by the language model to the application backend 420, which then sends these data fragments to the application frontend 410 to be displayed on the user interface (i.e., the chatbot's answer). In some embodiments, the application frontend 410 and application backend 420 may connect with any protocol, and the present disclosure is not limited in this regard.

In this embodiment, the application frontend 410 is related to a chatbot, but in other embodiments, it may also be an image generation tool, code generation tool, summarization tool, etc., and the present disclosure is not limited in this regard.

Through the technical means disclosed in this disclosure, the data fragments output by the language model 132 are temporarily stored in the stream pool, and when the client 110 queries about the task, the data fragments may be sent to the application backend 420 in real-time, and subsequently presented on the application frontend 410, thus reducing the waiting time for users to see the answer.

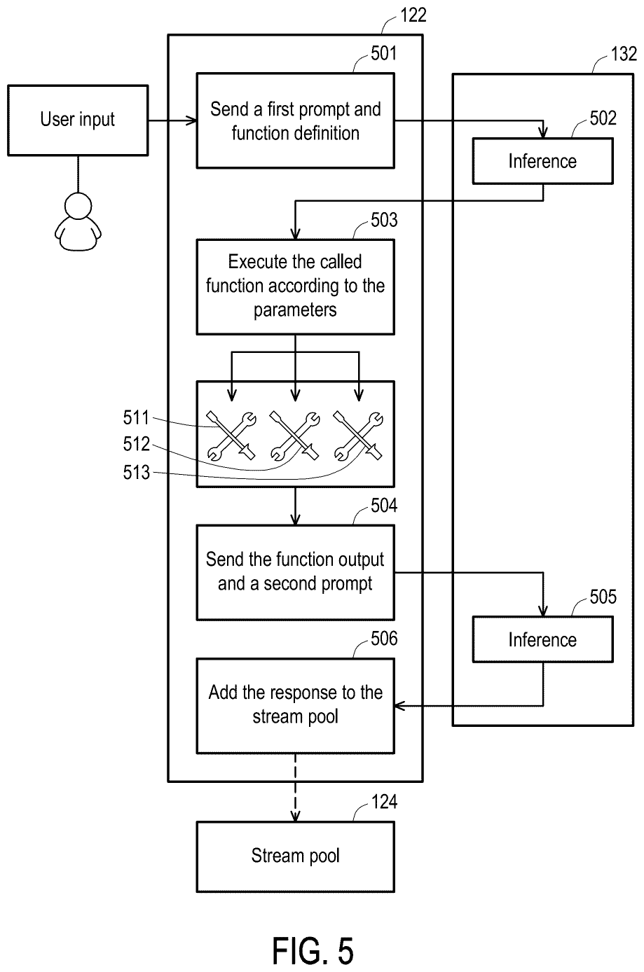

As mentioned above, the server 120 serves as an intermediary between the client 110 and the language model 132. In addition to calling the language model 132, the server 120 may also use any cloud service 131, or the server 120 itself may execute functions to assist in completing tasks. In some embodiments, the server 120 may implement function calls. FIG. 5 is a flowchart illustrating the implementation of function calls according to an embodiment. Please refer to FIG. 5. The worker application 122 is used as an example for explanation here. User input is converted into requests and tasks. At step 501, a first prompt and function definition corresponding to this request are obtained and sent to the language model 132. The first prompt may include the user's input, and the function definition may be extracted from a default database or provided by the cloud service 131. In some embodiments, these functions belong to REST (Representational State Transfer) application programming interfaces. For example, if the user input is “Please translate the file at the following link to English, https://file.to.trans/”, the function definition includes definitions for a file translator and an image recognizer. In this embodiment, the worker application 122 sends multiple function definitions, and the language model 132 determines which function to call.

After receiving the first prompt and function definition, at step 502, the language model 132 performs inference to determine the function to be called (referred to as a called function) and parameters for this called function. There is no limitation on the number of called functions and parameters here. At step 503, the worker application 122 receives the called function from the language model 132 and at least one parameter corresponding to this called function. Here, it is assumed that there are a total of three called functions 511-513, and then the worker application 122 executes the corresponding called functions 511-513 according to the parameters to obtain a function output. Continuing with the above example, the output of the language model 132 is “Call function: file translator. Parameters: {file location: https://file.to.trans/; translation language: English}”. The function output is “https://file.to.download/”.

At step 504, the worker application 122 sends the function output and a second prompt to the language model 132. For example, after combining the function output and the second prompt, it becomes “Execute file translator with parameters, get response from file translator: {translated file location: https://file.to.download/}”. At step 505, the language model 132 performs inference and sends the response to the worker application 122. The response from the language model 132 may be, for example, “File translation completed, here is the download link https://file.to.download/”. At step 506, the worker application 122 adds this response to the stream pool. Subsequent steps are as shown in FIG. 2 or FIG. 3, and the description will not be repeated here.

Since the output of the language model is mostly text, other functions are needed if other features (such as website search) are added. When calling functions, tasks such as handling parameter formats and selecting appropriate functions would increase the development complexity of the application frontend 410 or application backend 420. However, according to the process of FIG. 5, function calls are completed by the server 120. In addition, the server 120 can also work with other application frontends and application backends, meaning that multiple applications can share the server 120. Having the server 120 to do the function calls can reduce the cost of duplicate development.

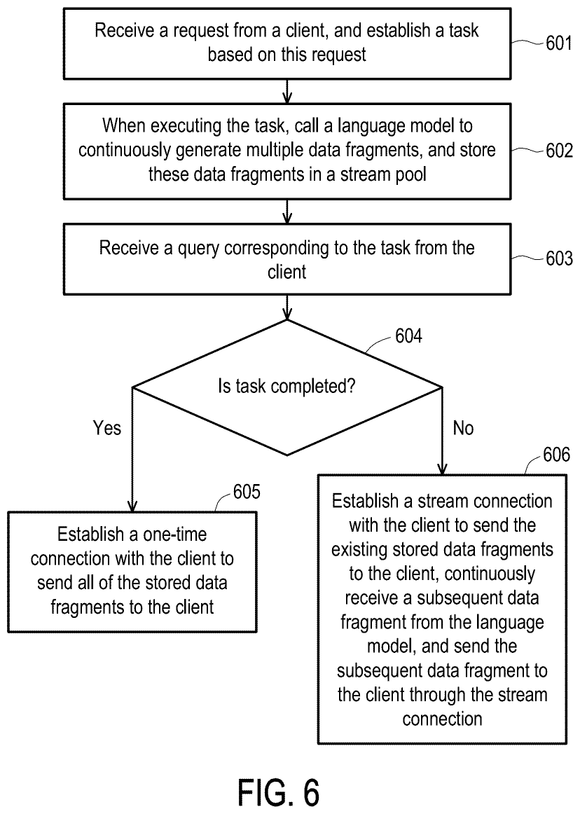

FIG. 6 is a flowchart illustrating a stream transmission method according to an embodiment, which may be executed by a computer system, such as the server 120 mentioned above. At step 601, a request is received from a client, and a task is established based on this request. At step 602, when executing the task, a language model is called to continuously generate multiple data fragments, and these data fragments are stored in a stream pool. At step 603, a query corresponding to the task is received from the client. At step 604, it is determined whether the corresponding task is completed. In response to the task being completed, at step 605, a one-time connection is established with the client to send all of the stored data fragments to the client. In response to the task not yet being completed, at step 606, a stream connection is established with the client to send the existing stored data fragments to the client, continuously receive a subsequent data fragment from the language model, and send the subsequent data fragment to the client through the stream connection. Each step in FIG. 6 has been explained in detail as above, so the description will not be repeated here. It is worth noting that each step in FIG. 6 may be implemented as multiple codes or circuits, and the disclosure is not limited in this regard. In addition, the method of FIG. 6 may be used in conjunction with the above embodiments or used independently; in other words, other steps may also be added between the steps of FIG. 6.

In the disclosure, when the server receives a query about a task from the client, the server will first determine whether this task has been completed. If the task has been completed, the server will establish a one-time connection, a Server-Sent Event (SSE) connection, with the client to send the corresponding data fragments to the client. If the task has not been completed, the server will establish a stream connection with the client to send the corresponding data fragments to the client. After that, when the language model generates subsequent data fragments, the server will send these subsequent data fragments to the client through the stream connection. Accordingly, the client does not have to continuously send query requests to the server at certain time intervals to detect the status of task execution. Still, the language model will continuously generate data fragments, which are stored in the stream pool. Even the server suddenly stops to send the data fragments to the client, the data fragments will not be lost.

In the disclosure, the server establishes different connections according to whether the task has been completed, and when the task has not been completed, data is sent in a streaming way, which can avoid unnecessary polling. In addition, when establishing a stream connection, the connection is not closed after transmitting data fragments, such that there is no need to re-establish the connection when sending subsequent data fragments. According to the way, if the task has not been completed, once the language model generates new data fragments, these data fragments will be sent to the client through the stream connection, which can reduce the waiting time for the client to receive data fragments. Accordingly, the disclosure effectively reduces the resource consumption of the server while ensuring that the client can get task execution results in real time.

Although the disclosure has been disclosed as above with embodiments, it is not used to limit the disclosure. Any person with ordinary knowledge in the relevant technical field may make some modifications and refinements without departing from the spirit and scope of the disclosure. Therefore, the scope of protection of the disclosure should be based on the appended claims.

What is claimed is:

1. A stream transmission method for a computer system, the stream transmission method comprising:
receiving a request from a client, and establishing a task according to the request;
when executing the task, a plurality of data fragments being generated continuously by calling a language model, and the plurality of data fragments being stored in a stream pool;
receiving a query corresponding to the task from the client, and determining whether the task is completed;
in response to the task being completed, establishing a one-time connection with the client to send the plurality of data fragments to the client; and
in response to the task not yet being completed, establishing a stream connection with the client to send an existing stored data fragments to the client, and a subsequent data fragment being continuously received from the language model, and the subsequent data fragment being sent to the client through the stream connection.

2. The stream transmission method as claimed in claim 1, further comprising:
establishing a task queue, and adding the task to the task queue;
executing a worker application to retrieve the task from the task queue; and
executing the task by the worker application.

3. The stream transmission method as claimed in claim 2, further comprising:
obtaining a first prompt and a function definition corresponding to the request, and the first prompt and the function definition being sent to the language model;
receiving a called function from the language model and one or more parameters corresponding to the called function; and
executing the called function by the worker application according to the one or more parameters to obtain a function output.

4. The stream transmission method as claimed in claim 3, further comprising:
sending the function output and a second prompt to the language model, and receiving a response from the language model; and
adding the response to the stream pool.

5. The stream transmission method as claimed in claim 1, wherein the client is an application backend, the stream transmission method further comprising:
receiving a user input from an application frontend by the application backend; and
generating the request according to the user input by the application backend.

6. The stream transmission method as claimed in claim 1, further comprising:
in response to the client losing the plurality of data fragments, retrieving the plurality of data fragments from the stream pool and sending the data fragments to the client.

7. The stream transmission method as claimed in claim 1, further comprising:
in response to the task being completed, storing a task result formed by the plurality of data fragments in a database.

8. The stream transmission method as claimed in claim 7, wherein the step of determining whether the task is completed includes:
querying whether the database includes the task result;
in response to the database not including the task result, determining that the task is not yet completed; and
in response to the database including the task result, determining that the task is completed.

9. The stream transmission method as claimed in claim 8, wherein in response to the task being completed, the step of establishing the one-time connection with the client to send all the plurality of data fragments to the client includes:
retrieving the task result from the database, and sending the task result to the client.

10. The stream transmission method as claimed in claim 1, wherein the request, the one-time connection and the stream connection conform to a HyperText Transfer Protocol (HTTP), and the stream connection is a Server-Sent Event (SSE) connection.

11. A stream transmission system, comprising:
a client; and
a server, communicatively connected to the client and configured to receive a request from the client, and establish a task according to the request,
wherein when executing the task, a plurality of data fragments are continuously generated by calling a language model via the server, and the plurality of data fragments are stored in a stream pool,
the server is configured to receive a query corresponding to the task from the client, and determine whether the task is completed,
in response to the task being completed, the server is configured to establish a one-time connection with the client to send the plurality of data fragments to the client,
in response to the task not yet being completed, the server is configured to establish a stream connection with the client to send an existing stored data fragments to the client, a subsequent data fragment is continuously received from the language model, and the subsequent data fragment is sent to the client through the stream connection.

12. The stream transmission system as claimed in claim 11, wherein the server is further configured to establish a task queue, and add the task to the task queue,
wherein the server is configured to execute a worker application to retrieve the task from the task queue and execute the task by the worker application.

13. The stream transmission system as claimed in claim 12, wherein the server is further configured to obtain a first prompt and a function definition corresponding to the request, and the first prompt and the function definition are sent to the language model, and receive a called function from the language model and one or more parameters corresponding to the called function,
wherein the server is further configured to execute the called function according to the one or more parameters to obtain a function output.

14. The stream transmission system as claimed in claim 13, wherein the server is further configured to send the function output and a second prompt to the language model, receive a response from the language model, and add the response to the stream pool.

15. The stream transmission system as claimed in claim 11, wherein the client is an application backend,
wherein the application backend receives a user input from an application frontend, and generates the request according to the user input.

16. The stream transmission system as claimed in claim 11, wherein in response to the client losing the plurality of data fragments, the server retrieves the plurality of data fragments from the stream pool and sends the plurality of data fragments to the client.

17. The stream transmission system as claimed in claim 11, wherein
in response to the task being completed, the server is configured to store a task result formed by the plurality of data fragments in a database.

18. The stream transmission system as claimed in claim 17, wherein the server is configured to query whether the database includes the task result,
in response to the database not including the task result, the server determines that the task is not yet completed,
in response to the database including the task result, the server determines that the task is completed.

19. The stream transmission system as claimed in claim 18, wherein in response to the task being completed, the server is configured to retrieve the task result from the database, and send the task result to the client.

20. The stream transmission system as claimed in claim 11, wherein the request, the one-time connection and the stream connection comply with a HyperText Transfer Protocol (HTTP), and the stream connection is a Server-Sent Event (SSE) connection.
